(19) United States
(12) Patent Application Publication
(10) Pub. No.: US 2009/0092054 A1
(43) Pub. Date: Apr. 9, 2009

(54) METHOD FOR PROVIDING NOTIFICATIONS OF A FAILING NODE TO OTHER NODES WITHIN A COMPUTER NETWORK

(76) Inventors: Matthew C. Compton, Tucson, AZ (US); Andrew G. Hourselt, Tucson, AZ (US); Michael R. Maletich, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/869,370

(22) Filed: Oct. 9, 2007

(51) Int. Cl. H04L 12/26

(52) U.S. Cl. 370/242

(57) ABSTRACT

A method for providing failure notifications to dependent nodes within a computer network is disclosed. A first node monitors data traffic within a computer network. If the data traffic includes data exchanged between the first node and a second node, the first node adds the second node to a list of interested nodes stored within the first node. If the first node experiences an error, the first node generates an error notification packet that includes a hop limit value that corresponds to a pre-defined level of nodes within the computer network that the error notification packet may propagate. The first node sends the error notification packet with the hop limit value to the second node and other nodes within the list of interested nodes. After receiving the error notification packet, the second node decrements the hop limit, performs one or more actions, and if the hop limit value is greater than zero, the second node also forwards the error notification packet to each node within its list of interested nodes.

### BACKGROUND OF THE INVENTION

1. Technical Field

The present invention relates to computer networks in general, and more particularly, to a method for providing notifications of a failing node to other nodes within a computer network.

2. Description of Related Art

High-availability computer networks typically include multiple interconnected nodes (or computer systems). Since the processing load of a computer network may be distributed across multiple nodes, the nodes within a high-availability computer network are becoming increasingly interdependent. If one node within a computer network experiences a failure, the problem can impair the performance of other nodes within the computer network.

In a conventional high-availability computer network, a failing node is aware of its own failure and can send a failure notification to a service personnel when a problem occurs. However, a node that depends on the failing node will continue to operate normally (i.e., without any knowledge of the failure) until the node that depends on the failing node attempts to contact the failing node. Upon learning of the failure node, the node that depends on the failing node must handle the unexpected failure in a reactive manner. Furthermore, the node that depends on the failing node typically does not have the ability to determine the details of a failure occurring on another node. Thus, a huge amount of time and resources can be used to determine the cause, severity, and potential corrective actions for a failing node.

Consequently, it would be desirable to provide an improved method for supplying notifications of a failing node to other nodes within a computer network.

### SUMMARY OF THE INVENTION

In accordance with a preferred embodiment of the present invention, a first node monitors data traffic within a computer network. If the data traffic includes data exchanged between the first node and a second node, the first node adds the second node to a list of interested nodes stored within the first node. If the first node experiences an error, the first node generates an error notification packet that includes a hop limit value that corresponds to a pre-defined level of nodes within the computer network that the error notification packet may propagate. The first node sends the error notification packet with the hop limit value to the second node and other nodes within the list of interested nodes. After receiving the error notification packet, the second node decrements the hop limit, performs one or more actions, and if the hop limit value is greater than zero, the second node also forwards the error notification packet to each node within its list of interested nodes.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a computer network in which a preferred embodiment of the present invention is incorporated;

FIG. 2A is a diagram of a memory of a node within the computer network of FIG. 1, in accordance with a preferred embodiment of the present invention;

FIG. 2B is a diagram of an error notification packet, in accordance with a preferred embodiment of the present invention; and

FIG. 3A is a high-level logic flow diagram of a method for generating lists of interested nodes within the computer network of FIG. 1, in accordance with a preferred embodiment of the present invention;

FIG. 3B is a high-level logic flow diagram of a method for providing notifications of a failing node to other nodes within the computer network of FIG. 1, in accordance with a preferred embodiment of the present invention; and

FIG. 3C is a high-level logic flow diagram of a method for reacting to notifications of a failing node within the computer network of FIG. 1, in accordance with a preferred embodiment of the present invention.

### DETAILED DESCRIPTION OF A PREFERRED EMBODIMENT

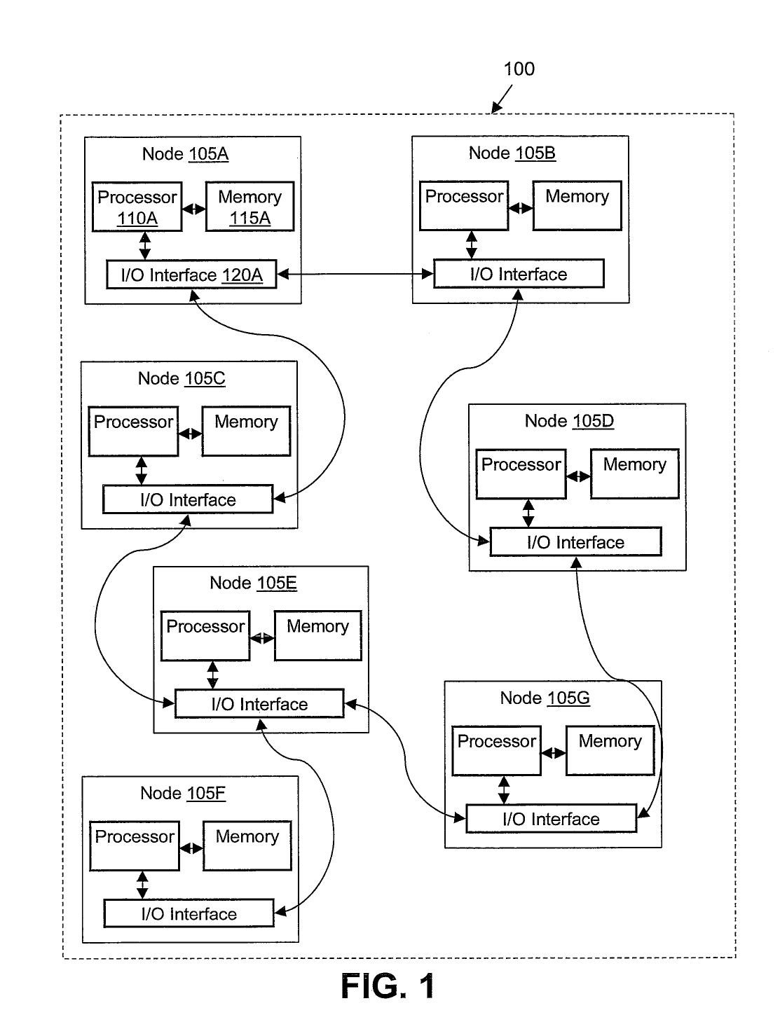

With reference now to the drawings, and in particular to FIG. 1, there is depicted a block diagram of a computer network in which a preferred embodiment of the present invention is incorporated. As shown, a computer network 100 includes multiple nodes 105A through 105G. As utilized herein, a node refers to a computer system or other processing device within computer network 100. Computer network 100 may be a local-area network (LAN), a wide-area network (WAN), or a distributed network, such as the Internet.

For the present embodiment, each of nodes 105A-105G within computer network 100 is similarly configured and includes a processor, a memory, and an input/output (I/O) interface. For example, node 105A includes a processor 10A, which is coupled to a memory 115A and an I/O interface 120A. I/O interface 120A enables node 105A to communicate with one or more other nodes, such as node 105B and node 105C, within computer network 100.

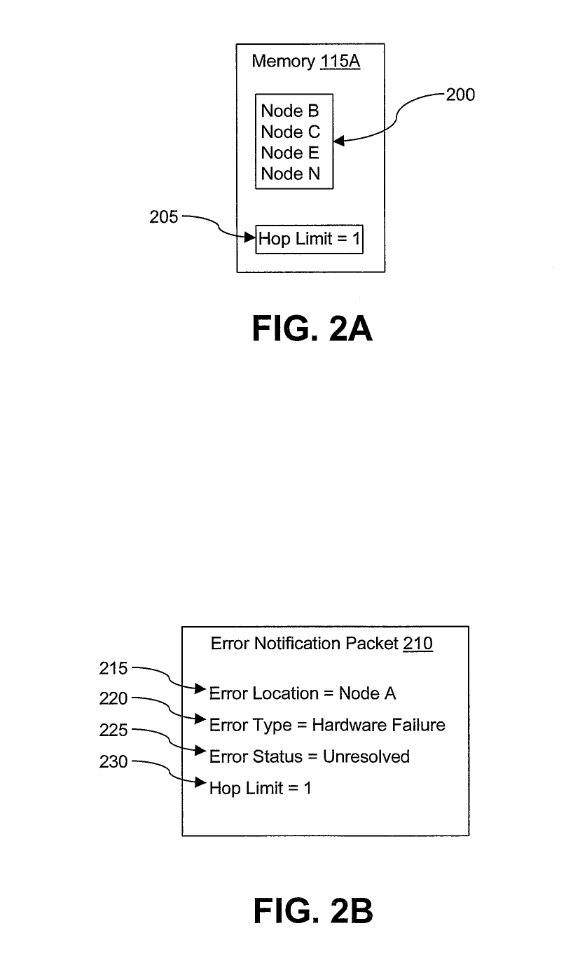

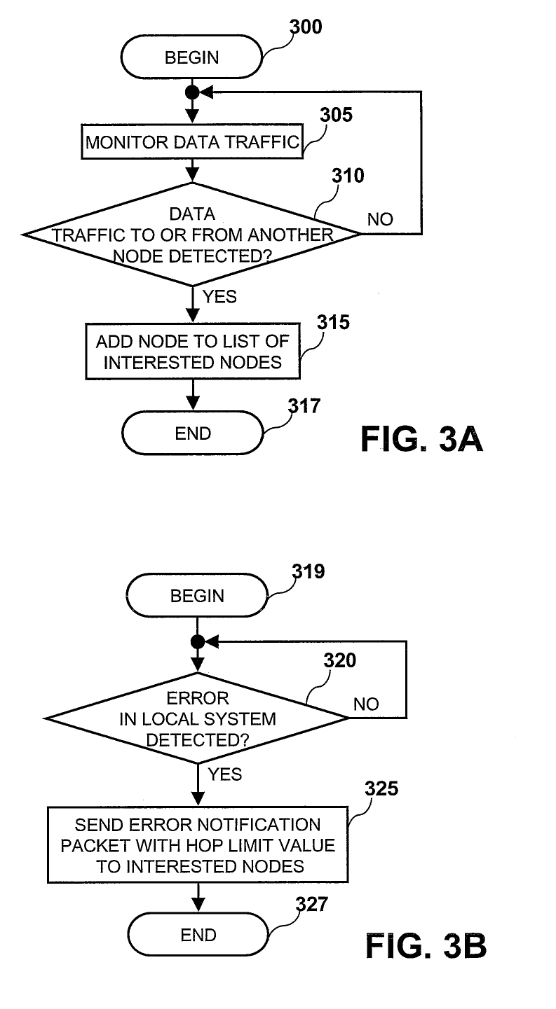

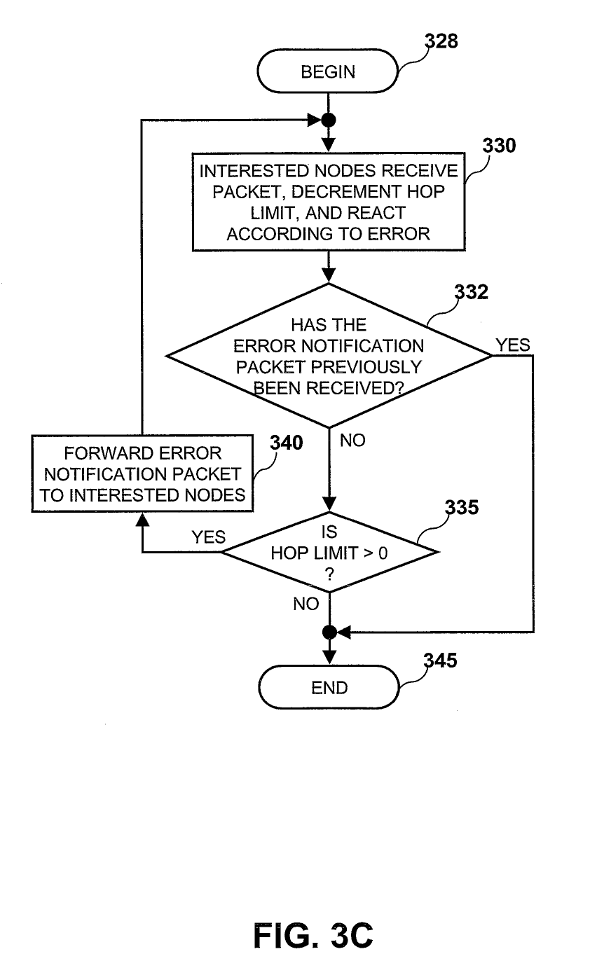

With reference now to FIG. 2A, there is illustrated a block diagram of memory 115A within node 105A from FIG. 1, in accordance with a preferred embodiment of the present invention. As shown, memory 115A includes a list of interested nodes 200 and a hop limit counter 205. Interested nodes list 200 includes one or more nodes that node 105A has previously communicated with (i.e., sent data to and/or received data from). Node 105A updates interested nodes list 200 according to the process illustrated in FIG. 3, which will be discussed in details below.

With the present invention, a node that experiences an error sends an error notification packet to one or more interested nodes, and in turn, each of which may then send its own error notification packet to their own list of interested nodes. A hop limit counter, such as hop limit counter 205, contains a pre-defined value that determines how far out within a computer network an error notification packet will propagate, and each error notification packet contains the value from the hop limit counter of the node that sends the error notification packet.

For example, if node 105A experiences an error, node 105A will send an error notification packet to other nodes. Since interested nodes list 200 include node B, node C, node E, and node N, node 105A will send an error notification packet to nodes B, C, E and N, and each of which will, in turn, send its own error notification packet to other nodes according to their respective interested nodes list. Since the value within hop limit counter 205 is 1, the error notification packet can only propagate to exactly one more level of nodes, and each of nodes B, C, E and N will only forward its own error notification packet to nodes on its interested nodes list.

Referring now to FIG. 2B, there is illustrated a block diagram of an error notification packet, in accordance with a preferred embodiment of the present invention. As shown, an error notification packet 210 includes an error location field 215, an error type field 220, an error status field 225, and a hop limit value field 230. Error location field 215 contains the node from which error notification packet 210 was generated. Error type field 220 provides information corresponding to the nature of the error (e.g., hardware failure, software failure, connectivity failure, or data integrity error). Error status field 225 provides information corresponding to the status of the error (e.g., unresolved, repair in progress, or resolved). Hop limit value field 230 includes a hop limit value from the hop limit counter of a sending node. A node may send an initial error notification packet when an error occurs, and the node may subsequently send a second error notification packet after the error has been resolved.

Referring now to FIG. 3A, there is illustrated a high-level logic flow diagram of a method for generating lists of interested nodes within a computer network, in accordance with a preferred embodiment of the present invention. Starting at block 300, a node (such as node 105A from FIG. 1) monitors data traffic in a computer network, as depicted in block 305. A determination is then made whether or not the node has detected data traffic to and/or from another node, as shown in block 310. If the node has not detected any data traffic to and/or from another node, the process returns to block 305 to continue monitoring data traffic. Otherwise, if the node has detected data traffic to and/or from another node, the node adds the node corresponding to the data traffic to a list of interested nodes (such as interested nodes list 200 from FIG. 2A), as depicted in block 315, and the process terminates at block 317.

Referring now to FIG. 3B, there is illustrated a high-level logic flow diagram of a method for providing notifications of a failing node to other nodes within a computer network, in accordance with a preferred embodiment of the present invention. Starting at block 319, a determination is made whether or not a node has detected any error within its own operation (after the node has performed a local health check), as shown in block 320. If the node has not detected any errors within its own operation (i.e., the node is operating normally), the process returns to block 320. Otherwise, if the node has detected one or more errors occurred within its own operation, the node generates an error notification packet (such as error notification packet 210 from FIG. 2B) having a hop limit value, and the node sends the error notification packet to each node on the list of interested nodes, as shown in block 325. The process subsequently terminates at block 327.

Referring now to FIG. 3C, there is illustrated a high-level logic flow diagram of a method for reacting to notifications of a failing node within a computer network, in accordance with a preferred embodiment of the present invention. The process begins at block 328. Each node on the list of interested nodes receives an error notification packet sent by a failing node, decrements the hop limit value of the error notification packet by one, and performs one or more actions based on factors that include the values of error type and error status, as depicted in block 330. Possible actions that can be performed by a node that receives an error notification packet may include, but are not limited to, the following:
a. calling a central service center on behalf of the malfunctioning node (e.g., if the malfunctioning node is experiencing a connectivity error);
b. forwarding the error notification packet to all nodes within the list of interested nodes on behalf of the malfunctioning node (e.g., if a grid connection or some other component of a distributed network is down);
c. sharing one or more resources with the malfunctioning node (e.g., if the notified node includes a duplicate copy of a database that has become corrupted in the malfunctioning node); and/or
d. entering a read-only and/or off-line state for a pre-defined time period (e.g., if the failure may impair the data integrity of neighboring nodes).

Next, a determination is made whether or not the node that received the error notification packet has previously received the error notification packet, as shown in block 332. If the node that received the error notification packet has previously received the error notification packet, the process terminates at block 345. Otherwise, if the node that received the error notification packet has not previously received the error notification packet, another determination is made whether or not the hop limit value included in the error notification packet is greater than 0, as shown in block 335. If the hop limit value is not greater than 0, the node that received the error notification packet will not forward the error notification packet, and the process terminates at block 345. Otherwise, if the hop limit value is greater than 0, the node that received the error notification packet forwards the error notification packet to each node on its corresponding list of interested nodes, as depicted in block 440, and the process returns to block 330. As mentioned above, the maximum number of error notification packets that can be forwarded to other nodes is dictated by the value of the hop limit value in the first error notification packet.

As has been described, the present invention provides an improved method for providing notifications of a failing node to other nodes within a computer network.

While an illustrative embodiment of the present invention has been described in the context of a fully functional storage system, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method for providing notifications of a failing node to other nodes within a computer network, said method comprising:
generating an interested node list in a node, wherein said interested node list includes any other node that has previously communicated with said node;
in response to a determination that said node is experiencing an error, sending an error notification packet from said node to each node on said interested nodes list; and
after the receipt of said error notification packet, performing one or more actions by a node on said interested nodes list.

2. The method of claim 1, wherein said method further includes forwarding said error notification packet by said node on said interested nodes list to a node on a local interested nodes list stored within said node on said interested nodes list according to a hop limit value, wherein said hop limit value corresponds to a pre-defined level of nodes within said computer network that said error notification packet may propagate, wherein said hop limit is decremented by said node on said interested nodes list.

3. The method of claim 1, wherein said error notification packet includes a hop limit value field for containing a hop limit value from a hop limit counter of said node.

4. The method of claim 1, wherein nature of error includes hardware failure, software failure, connectivity failure, or data integrity error.

5. The method of claim 1, wherein status of error field includes unresolved, repair in progress, or resolved.

6. The method of claim 1, wherein said one or more actions include:
calling a central service center on behalf of said node;
forwarding said error notification packet to all nodes on said interested nodes list on behalf of said node;
sharing one or more resources with said node;
entering a read-only state for a first pre-defined time period; and
entering an offline state for a second pre-defined time period.
